(19) United States
(12) Patent Application Publication
(10) Pub. No.: US 2021/0293024 A1
(43) Pub. Date: Sep. 23, 2021

(54) VERSATILE MANUAL CRIMPER FOR ROOF SEAMING

(71) Applicant: Terry L. Rider, Corinth, MS (US)

(72) Inventor: Terry L. Rider, Corinth, MS (US)

(21) Appl. No.: 16/822,004

(22) Filed: Mar. 17, 2020

(51) Int. Cl. E04D 3/367; B21D 39/02; E04D 15/04

(52) U.S. Cl. CPC E04D 3/364; E04D 15/04; B21D 39/02

(57) ABSTRACT

A manual crimping device for roof seaming purposes that includes interchangeable components to allow for myriad different crimping configurations is disclosed. Such a device (and method of roof seaming utilization therewith) permits a user a selection of many different crimping results, whether in terms of crimp angle, crimp indentations, and/or crimp folds. A two-station crimp application configuration within the subject device further permits the user the ability to deform a subject seam to a proper final result, basically providing an initial crimp operation with a separate second and subsequent crimp to the same seam until reaching final status. The interchangeable components, being at least an anvil, a blade, and a hook, allows for these myriad different results without having to utilize and thus possess such a myriad different number of manual crimpers. A manual crimping method utilizing such a versatile device for different crimping results is encompassed herewith as well.

### FIELD OF THE DISCLOSURE

This disclosure pertains to a manual crimping device for roof seaming purposes that includes interchangeable components to allow for myriad different crimping configurations. Such a device (and method of roof seaming utilization therewith) permits a user a selection of many different crimping results, whether in terms of crimp angle, crimp indentations, and/or crimp folds. A two-station crimp application configuration within the subject device further permits the user the ability to deform a subject seam to a proper final result, basically providing an initial crimp operation with a separate second and subsequent crimp to the same seam until reaching final status. The interchangeable components, being at least an anvil, a blade, and a hook, allows for such myriad different results without having to utilize and thus possess such a myriad different number of manual crimpers. A manual crimping method utilizing such a versatile device for different crimping results is encompassed herewith as well. add or remove components to the blade or anvil to allow it to be used on many different panel design

### BACKGROUND OF THE PRIOR ART

For as long as sheet metal has been utilized for buildings and like structures, the need for connection adjacent panels from such materials has been required. Since entire large structures cannot be constructed from single metal components, individual portions, in the way of panels, sheets, and the like, have been formed and then connected in various ways. The most prevalent manner of connection has been to place adjacent panel ends over one another and then physically deform the panel ends along a seam to thereby extend the resultant composite in a reliable fashion. Although soldering and screw-type mechanisms are possibilities for such needed connections, such alternatives, though reliable in their own right, are much more labor intensive and expensive in comparison to the above-noted deformation procedures.

As such, the typical manner of providing such physical seams to adjacent sheet metal (or like) panels has been a manual crimping device wherein the user places two juxtaposed ends of a crimping jaw over the two panel ends and manually closes the jaw to apply the needed degree of crimp to ensure proper folding and thus interaction between the panels for a reliable seam. Such a device is applied either along the entire panel end connection line to create the necessary water-tight and wind-protective seam, or in specific locations along a subject seam where the panels are connected to the base building structure through clips. In any event, a typical manual crimper provides a single configuration for application to a subject seam, limiting the capability of such a device to a single type of roof panel installation. If the user needs to work on a different seam type or provide a different seam configuration, a different crimping device is typically needed.

Furthermore, the greater the actual entanglement of the seam through excessive deformations of both panel ends, the stronger the overall seamed composite. Thus, if the panel ends are physically manipulated in such a manner as to secure the panel ends together as tightly as possible, then such a resultant seam would be less susceptible to wind updraft damage as and water leakage as the forces required to separate such a seam would be excessive themselves. With a lower degree of deformation of the seam, the easier a wind updraft could detach the panel ends. Likewise, as noted above, the looser the seam, the easier water may enter the construction interior there through, not to mention the easier water could penetrate the seam itself increasing the potential for rust formation and deterioration itself at such locations.

Currently, as alluded to previously, single configuration manual crimping devices requiring total user maneuvering and physical movement of the jaw components is the standard in the industry. Such a device allows for thorough deformation and crimping on demand by ‘the user, although without guarantees of uniform application over an entire seam. Thus, although the capability of permitting effective seaming through single configuration manual crimping is possible with a relatively inexpensive manner of seaming in this manner, there are numerous drawbacks, unfortunately. For instance, the application of sufficient force to impart the needed seam strength may be limited through such a single configuration manual crimping device. The ability to achieve sufficiently strong seams between roof panels is thus limited due to such single configuration devices. Such an intensive manual labor device may necessitate repeated operations and excessive user activities for a suitable final seaming result. There is thus a notable need to provide a manual crimping device that allows for greater versatility upon selection of certain configurations to impart crimping angles, at least, on demand, rather than through repetitive or, for that matter, ineffective crimping with limited deflection and deformation components within a static device.

Hence, there remains a distinct need to provide the sheet metal composite industry with a highly reliable and effective, not to mention versatile, manual crimping mechanism that can provide capability of adjustment of configurations for different crimping results on demand. Unfortunately, to date, standard manual roof seaming crimpers lack such versatility within the sheet metal composite/metal edifice construction industry.

### ADVANTAGES AND SUMMARY OF THE DISCLOSURE

One distinct advantage of the present disclosure is the capability of applying different seam crimping results along any desired length of connected end roof panels through substituting any of three different component crimping parts. Another advantage is the capability of providing easy-to-change component parts within a manual seam crimper to impart such different crimping results on demand. With a two-station manual crimping device, another advantage is the ability to impart sufficient seaming through such a manual device with an initial crimp action and a subsequent deforming crimping action to the initial result.

Accordingly, this disclosure is directed to a manually operated crimping device for crimping a portion of a standing seam of adjacent metal panels when placed in a pre-selected location along said standing roof seam, wherein said standing seam is provided through contacting engagement of a male end of one metal panel properly nested within a female end of an adjacent metal panel, wherein, when overlapping one another, said standing seam is aligned as a substantially straight line having a vertical component rising to a horizontal component from which extends a flange component, and wherein said flange component extends at an angle of any measurement downward from said horizontal component of said standing seam; wherein said crimping device includes a manual crimping means to simultaneously bend substantially all of said flange component of said standing seam at the location at which said crimping device is placed (thereby creating a secured seam at the location at which said crimping procedure has occurred), and wherein said crimping means is interchangeable through the removal and substitution of at least one different crimping component selected from an anvil, a blade, and a jaw hook, wherein a multiple of different variations of said at least one different crimping component is provided to accord multiple variations of resultant crimping configurations within the same device on demand. The device may further include two separate stations with different crimping means within each station to apply different resultant crimping results to said standing seam during operation thereof. Such a device may be manually removed from a specific location and placed at a different one along the same (or a different seam) to create a proper secure connection (seam) at another location in the same manner. Such a disclosure further includes a method of utilizing such a manual, interchangeable, versatile crimping that may apply different crimping configurations to selected roof seams on demand and through interchanging of any combinations of said interchangeable crimping components to allow for any selected crimp results within the panel ends (edges) sufficient to provide a permanent and strong secured seam. Such a bend in the panel ends may be at any selected angle, from roughly 45 degrees to a full 180 degrees (a double bend, basically), with the understanding that if the flange component of the nested panel ends extends at an obtuse angle in relation to the horizontal component of the panel ends, then the angle of deformation would actually be greater than 90 degrees; in this respect, however, the capability of providing deformation through a bend in the panel ends wherein the flange component becomes parallel in relation to the horizontal component of the standing seam should be sufficient for this disclosed purpose. The crimping device as defined above with such interchangeable crimping means components permits any selected seaming result along a subject standing roof panels seam for resultant seaming configurations in relation to needed angles, indentations, etc., pursuant to seaming requirements, all with the utilization of the same crimping device base and the substitution of three different components that impart, in conjunction with one another, deformation results.

As alluded to above, manual seaming devices have been utilized within the metal building industry for such purposes for a significant period of time. However, such devices are still limited in terms of different available seaming results, particularly as they have a single crimping configuration, typically, rather than the versatile myriad available capabilities of the presently disclosed device. In other words, such prior devices were provided as single structures, or, possibly, with a single component that may be removed and substituted for (such as a blade). Though such a blade change may impart different characteristics to tha final seam from another blade, such a result is limited in and of itself as the angle of deflection would be the same, at least, and thus the actual results would not be much different overall than any other possible prior art device. The ability to utilize a device that allows for myriad changes has heretofore been lacking in this industry.

A user thus may have the ability to utilize a single base crimping mechanism and replace, as needed and on demand, any or all of the three components (anvil, blade, jaw hook), in any combination and as needed to impart, again, myriad different crimping configurations. This is of great facility to the industry as users may simply remove such component parts (whether one to three) and substitute any different types of structures (as long as they dimensionally fit in the spaces available and connect and attach appropriately, of course) to allow for such versatile results. Thus, as it concerns, for example, a blade, the structures thereof may be provided with certain thicknesses to impart different strengths to the subject seams when applied. Spacers may likewise be included to adjust the thickness thereof as needed (and thus would be considered part of such a possible substitute component). An anvil provides a deflection angle in relation to the blade. As such, different configurations thereof may be provided that accord such a distinct result with angles from, as noted above, 45 to 180 degrees. The jaw hook provides a stop to deflection through the crimping device and may be changed to reflect such desired results as well. For connection and attachment, bolts may be utilized to screw such components parts within the body of the crimping base (and removable as well through such a manner of connection, too). Such bolts thus apply sufficient force to retain the component parts in place as the application of force is employed on a subject seam, repeatedly. Such parts of the crimping device, from the base to the components parts noted above, may be of any material that imparts such necessary forces when manually applied. Such materials are selected from aluminum, steel, stainless steel, titanium, brass, and the like. Most preferred for cost and longevity purposes may be aluminum. Such bolts may be of the same materials as well.

Such manual crimping devices may be utilized along the entirety of a subject roof seam or may be utilized for priming of such a subject metal seams to a degree that the necessary deformations in the standing seams have already occurred in order to properly place other types of crimpers (automated types, for instance) in place on, for instance, a roof. Additionally, some roof systems do not require complete seaming along the standing seams in the first place, but only in certain areas at which clips or other connection devices are present to connect the metal panels to underlying purlins or like structural components. Thus, such a versatile manual crimping device may be of significance to allow for such different seaming configurations and results on demand rather than having to locate and transport multiple types of manual crimpers to a construction site. The need for such a versatile, manual, crimping crimping apparatus is apparent, particularly to allow for such substitutions of component parts on-site, and thus limiting the transport of storage of a single crimping base device rather than multiple devices for any seam configuration modifications or requirements.

Such a manual device is thus configured, with selected components in place as desired, to allow for a selected crimping blade (or board) to rotate at least 45 degrees as the user manually operates the device around a hinge. Such movement of the blade is directed by the anvil and the jaw hook (as discussed above) in relation to manipulation and control by a user to bend and deform a target flange component of a standing seam to a desired position to ultimately form a standing seam (such may prime, as noted above, a seam, as well, which leads to a finished seam). The standing seam itself is comprised of two ends of adjacent metal panels, one end configured to cover the other end in a male/female type relation with the male end exhibiting a vertical rise and a horizontal level extending substantially 90 degrees from the vertical rise. The female end will exhibit a like configuration, but with the vertical rise extending upward slightly further than that of the male end, thus allowing the horizontal level to rest on top of the male horizontal level. A flange component then extends from the female end downward from the horizontal level (at any angle, but preferably substantially 90 degrees therefrom) with an optional curved end portion to allow for further reliable nesting of the male and female panel ends, as well as potentially a stronger seam once the crimping/deforming procedure is accomplished. To that end, the manipulated crimping blade applies sufficient pressure and torque to bend the flange component of the standing seam inward toward the vertical component thereof until the flange is substantially parallel (or present at any desired location to provide a suitable seam) with the horizontal component. Again, as noted above, such a bend in the flange may be substantially 90 degrees (in one potentially preferred embodiment).

A particularly preferred embodiment of the disclosed manual crimping device includes two stations within the same structure wherein a first station includes component parts that are operated by a user to impart an initial seam deformation result and a second station that includes different component parts to impart, again, upon operation by a user, a finished result on the same seam. In such a manner, the first station is first placed upon a specific seam location and activated by the user manually initially over the same initial location to impart the finished seam crimping result thereafter. The user may then move along the subject seam to a different locatin and repeat the same procedure. The device may include two separate control arms for such a purpose with, of course, the first controlling the first station blade operation and the second arm allowing for manipulation of the blade within the second station.

Additionally, the entire apparatus, preferably being made from metal materials for strength and resilience, at least in terms of the working machinery that applies the sufficient pressures and torque to the target metal panel ends (standing seams) (such metal panels may be sheet metal, aluminum, and any other like material that is strong enough to provide effective shelter and protection from the elements, yet lightweight enough, at least in terms of individual panel and sizes utilized thereof, to be transported and lifted and aligned for seaming to occur). The handles for transport facilitation may be made from strong plastics, if desired. Preferably, however, as noted above, the overall construction is aluminum as it provides the necessary strength to the device and is still light in weight to permit ease in transport, lifting and maneuvering, as well.

In actual practice, the user would simply place a male and female end together in overlapping fashion to provide the standing seam noted above and ready for secured seaming. Thereafter, the user would then place the inventive manual crimper over a selected length of the standing seam, resting evenly upon the horizontal level produced thereby, and then would activate the crimper. The crimper itself includes a lengthwise blade (or board) that is aligned in substantially the same direction as the flange component of the standing seam and thus initially substantially perpendicular to the horizontal component thereof. This blade, being from 4 to 10 inches in length generally, although longer and shorter blades may be employed depending upon the configuration and size of the crimping device base. The anvil and jaw hook components are situated on the other side of the manual crimping device to, as alluded to previously, provide the directional pathway and stoppage point for the blade component upon manual operation thereof.

As the overall length of the crimping blade may vary, so too may the overall size and length of the overall apparatus itself. In actual practice, the height of the apparatus may not require a measurement beyond 24 inches itself as the torque supplied by the user through manipulation of the device (around a hinge, for example) does not require a significant length for such a purpose. Thus, the overall apparatus is rather compact and only the crimping blade length appears to create any potential issues in terms of the overall length of the unit.

Once the user has manually activated the crimping mechanism through rotation of the blade portion around a hinge, for instance, the user then moves the device in the opposite direction, effectively releasing the grip from around the subject roof seam. If a second station is utilized, then the device is lifted and placed in the same location and then manually operated again to finish the subject seam. As such, the user can continue crimping a specific site on the target standing seam as long as he wishes and then stop the utilization and manipulation of the crimping blade and move to another site that requires crimping along the standing seam. The user may choose to stay in one location for at least two crimping procedures simply to ensure that the secure seam has been accomplished beyond a single run. Such should not be necessary, but the user may, again, choose to do so and such would not be outside the scope of the overall disclosed method utilizing such a novel apparatus.

### BRIEF DESCRIPTION OF THE DRAWINGS

FIG. 1 is an isometric, partial cut-away view of a portion of a roof system utilizing a standing seam roof assembly.

FIGS. 2A, 2B, and 2C are side views of potential embodiments of some of many alternative, interchangeable component structures of the manual crimper blade, anvil, and jaw hook.

FIG. 3 is a side perspective view of another potential embodiment of an alternative interchangeable blade component.

FIG. 4 is a side perspective view of another potential embodiment of an alternative interchangeable anvil component.

FIG. 5 is a side perspective view of another potential embodiment of an alternative interchangeable jaw hook component.

FIG. 6 is a side perspective view of another potential embodiment of an alternative interchangeable anvil component.

FIG. 7 is a side perspective view of another potential embodiment of an alternative interchangeable jaw hook component.

FIG. 8 is a side perspective view of another potential embodiment of an alternative interchangeable blade component.

FIG. 9 is a side perspective view of another potential embodiment of an alternative interchangeable two-stage blade component.

FIG. 10 is a side cut-away view of an uncrimped roof seam with overlapping male and female edges of adjacent panels.

FIG. 11 is a side cut-away view of a crimped roof seam with overlapping male and female edges of adjacent panels as in FIG. 10.

FIG. 12 is a side view of a two-station manual crimping device including the interchangeable component described herein with the first station placed over an initially uncrimped roof seam.

FIG. 13 is a side view of the two-station manual crimping device of FIG. 12 including certain interchangeable components as described herein with the first station placed over an initially crimped roof seam.

FIG. 14 is a side view of the device of FIG. 12 with the second station placed over the same initially crimped seam and finished with a second seam.

FIG. 15 is a side view of a two-station manual crimping device including the interchangeable anvil component of FIG. 2B with the first station placed over an initially crimped roof seam.

FIG. 16 is a side view of a two-station manual crimping device including the interchangeable anvil component of FIG. 6 with the first station placed over an initially crimped roof seam.

### DETAILED DESCRIPTION OF THE DRAWINGS AND PREFERRED EMBODIMENTS

A better understanding of the present disclosure will be had when reference is made to the accompanying drawings, wherein identical parts are identified by identical reference numerals. Such a depiction is for a presentation of the potentially preferred embodiments of the disclosure and is not intended to limit the breadth of the disclosure in any manner. The ordinarily skilled artisan would have sufficient understanding and respect for this specific art in order to consider the true breadth of the disclosure itself in relation to the overall descriptions.

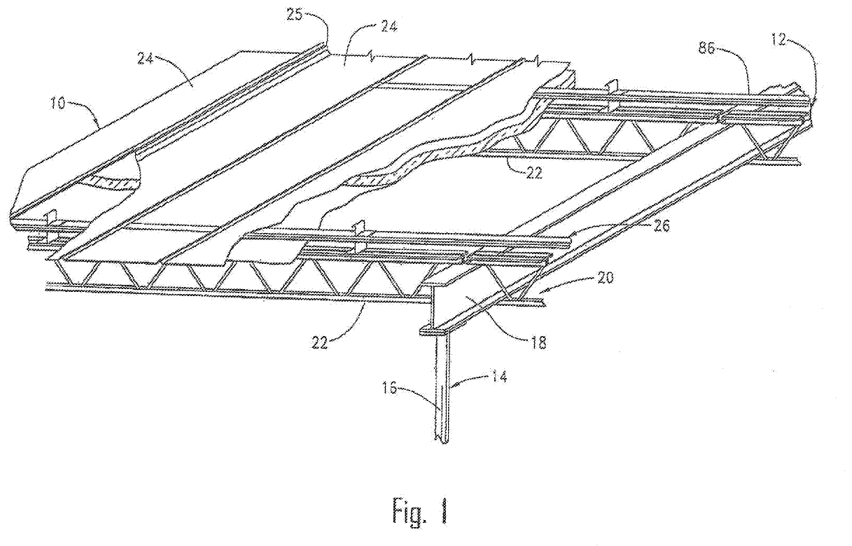

Referring to FIG. 1, there is depicted a pre-engineered building roof 10 supported by a pre-engineered building structure 12. Such a pre-engineered structure 12 comprises a primary structural system 14 including a number of upwardly extending column members 16 [to be connected to a base foundation (not illustrated)]. Also, the primary structural system 14 has a plurality of beams 18 which are supported by the column members 16.

Also included is a secondary structural system 20 including a number of open web beams 22 attached to and supported horizontally by the primary beams 18. Alternative structures may be employed in place of these web beams 22, if desired. A plurality of roof panels 24 are supported over the secondary structural assembly 20 by a plurality of panel support assemblies 26 and are attached to the upper flanges of the web beams 22. The roof panels 24, only portions of which are shown, are depicted as being standing seam panels with interlocking standing seams 25 connected by clip portions of the panel support assemblies 26. Alternatives to such clips may be practiced as well and other clips may be incorporated within the panels to hold them in place with the building skeletal portions noted above.

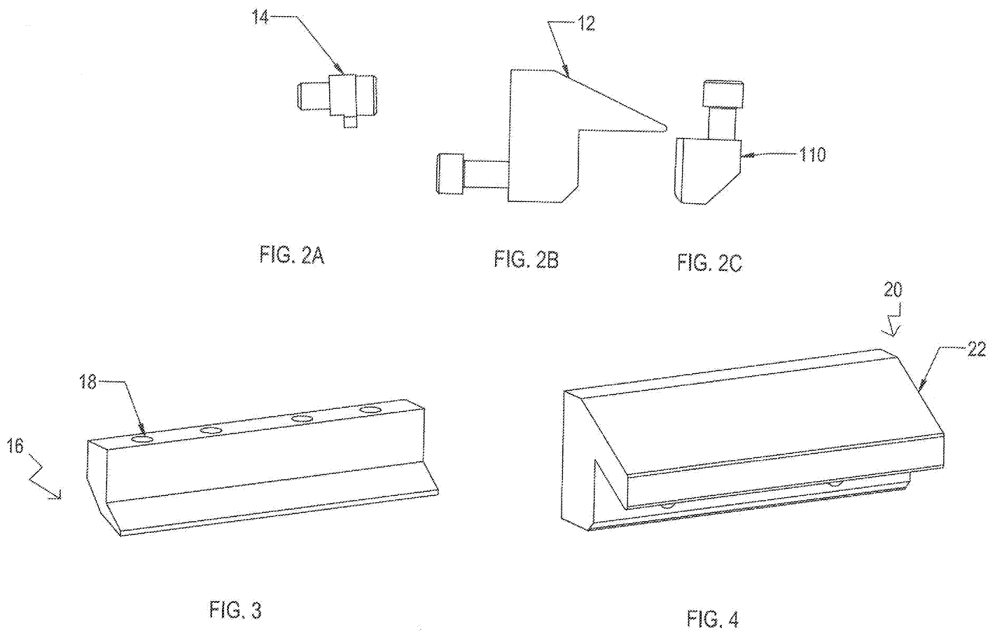

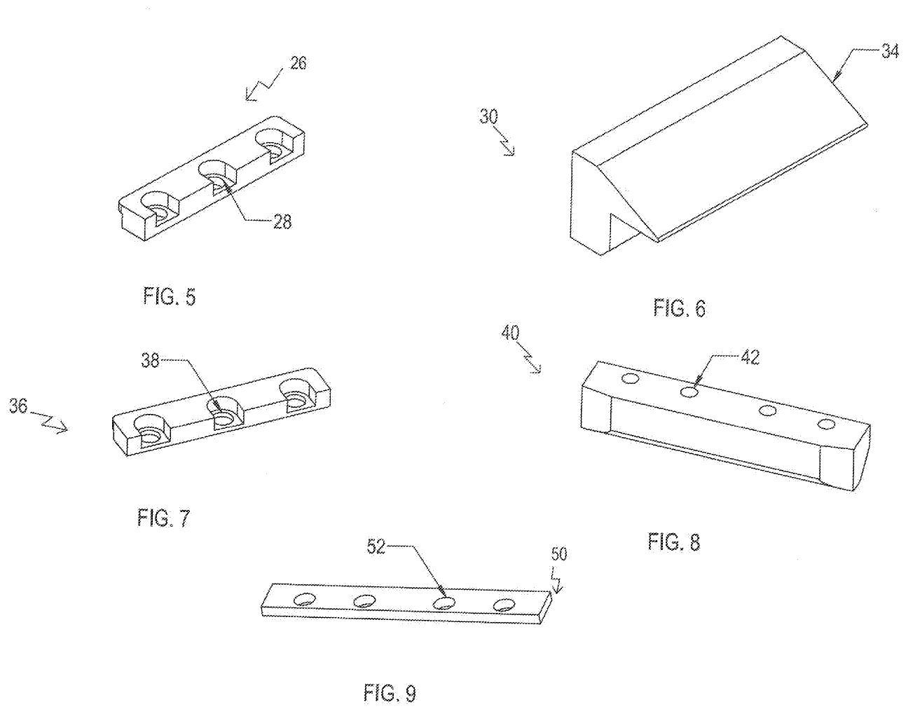

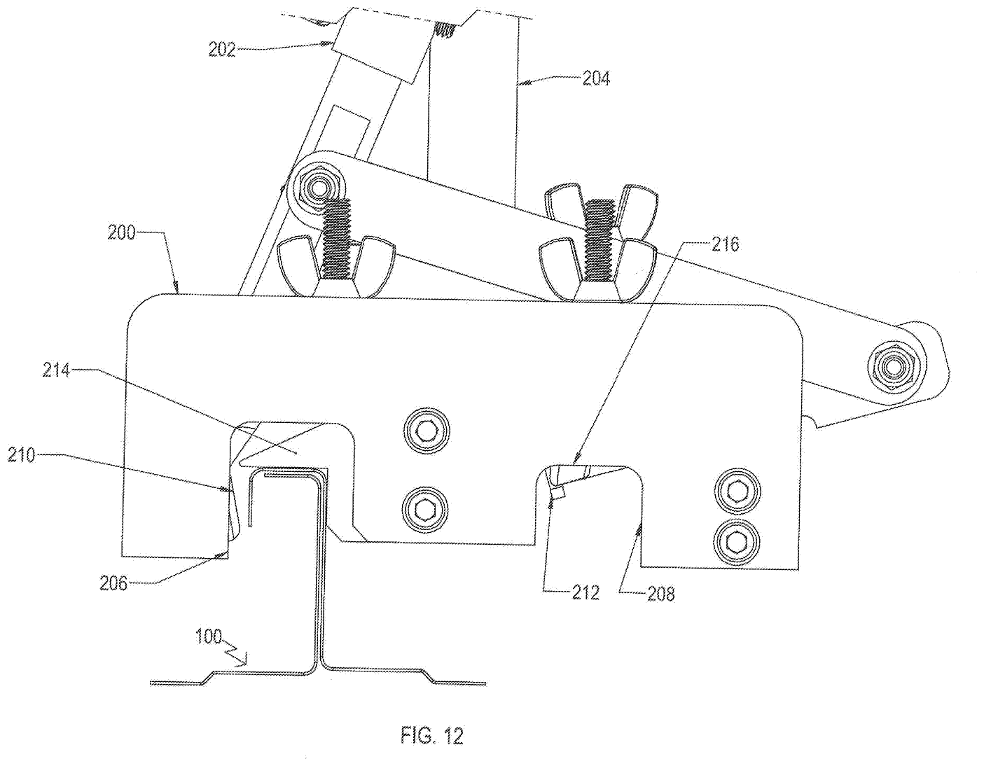

FIGS. 2A through 10 depict different interchangeable components of a subject manual crimping device (such as 200 in FIG. 12). In FIG. 2A, there is shown side views of a manual crimper blade 10, in FIG. 2B an anvil 12, and in FIG. 3 a jaw hook 14. In FIG. 3 there is shown a different type of blade 16 having openings 18 for bolt connections (and a spacer). FIG. 4 shows a perspective view of a different anvil 20 with an angled end 22 that acts as a directional guide for the blade 16 when manually operated. Likewise, the anvil includes openings (not illustrated) for bolt connections to the body of the manually crimping base (200 of FIG. 12). FIG. 5 shows a perspective view of a jaw hook 26 component in the same manner as the other two components 15, 20 with openings 28 for bolt connections. A different anvil 30 with openings (not illustrated) and an angled end 34 is shown in perspective view in FIG. 6, with a different jaw hook 36 in FIG. 7 with openings 38 for connections as above, and in FIG. 8 a different blade 40 with bolt openings 42. FIG. 9 shows a blade spacer 50 with bolt openings 52 as well. Such representations of components 10, 12, 14, 16, 20, 26, 30, 36, 40, 50, are merely a handful of possible components that may be interchanged within the crimping device (200 of FIG. 12) to impart myriad different crimping configurations within a single device on demand.

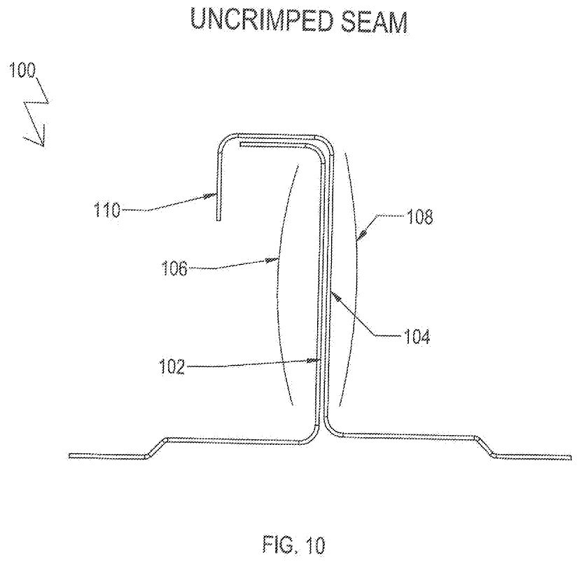

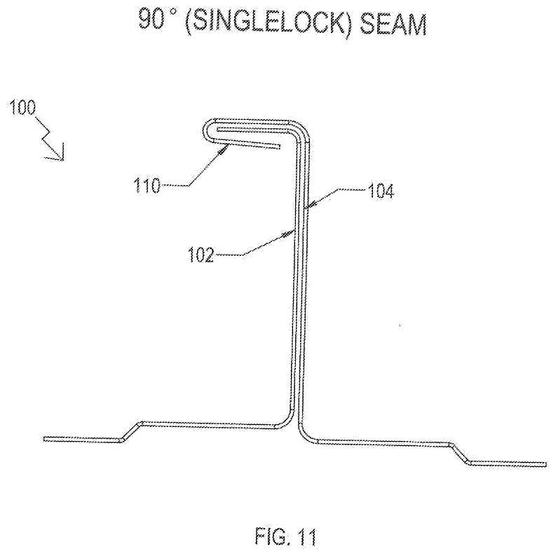

FIG. 10 shows a side cut-away view of a roof seam 100 with a male end panel 102, a female end panel 104, parallel vertical sections 106, 108, and a flange 110 from the female panel 104. FIG. 11 shows the same seam 100 as in FIG. 10 with the deformed flange 110 in place to provide contact between both panels 102, 104. Such a result is but one possible configuration provided by a manually crimping device as described herein.

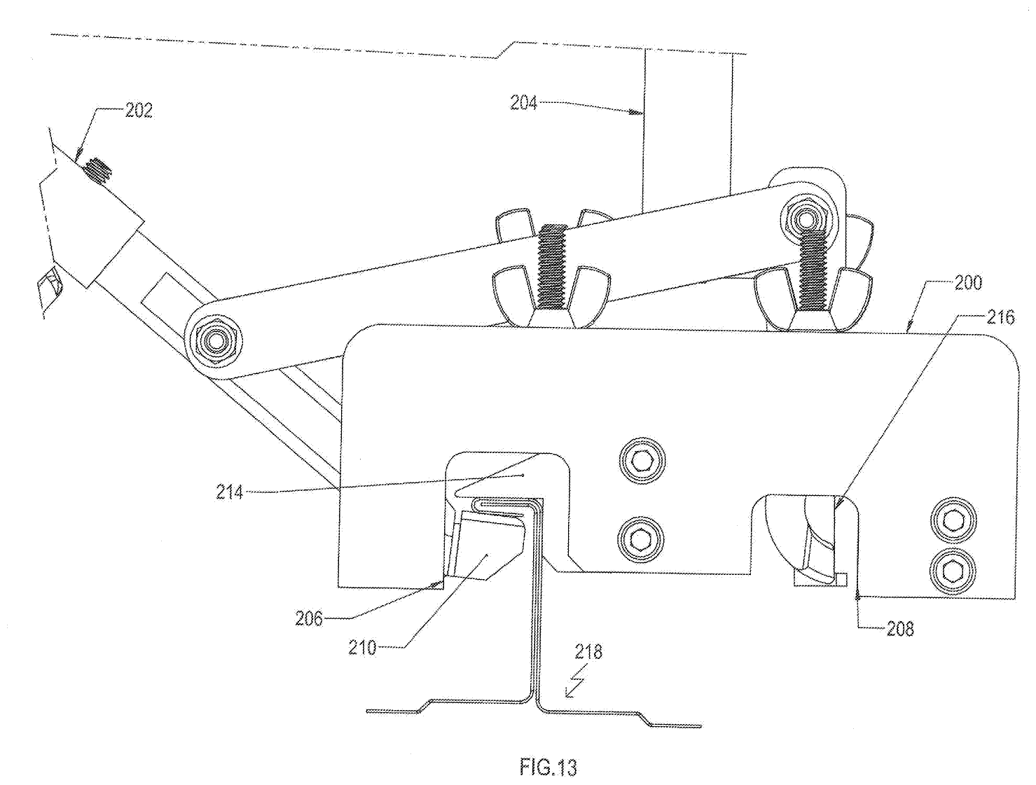

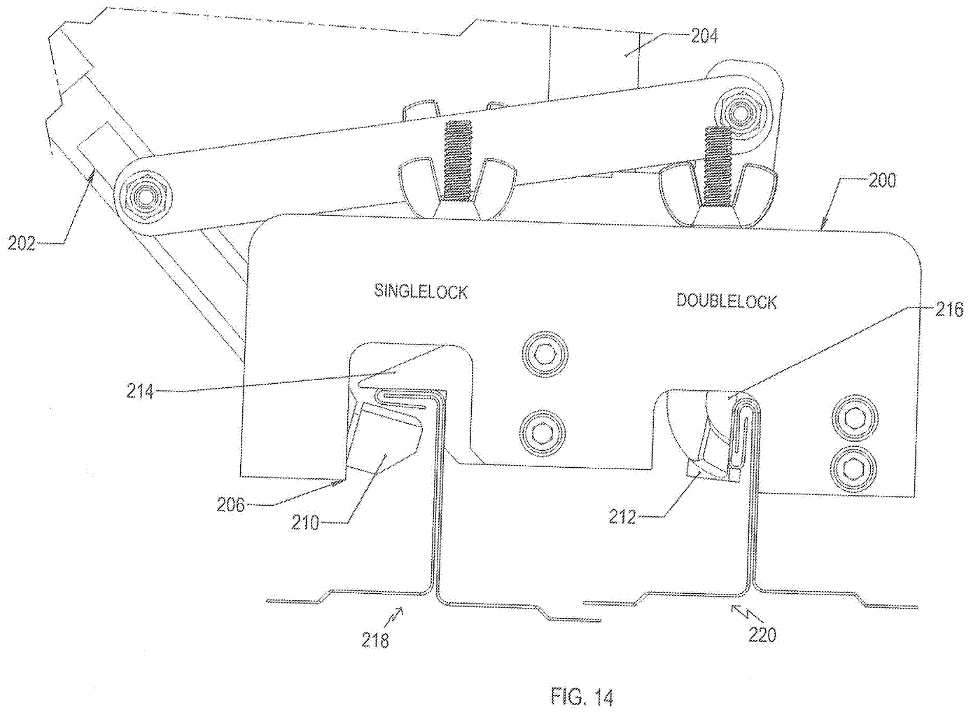

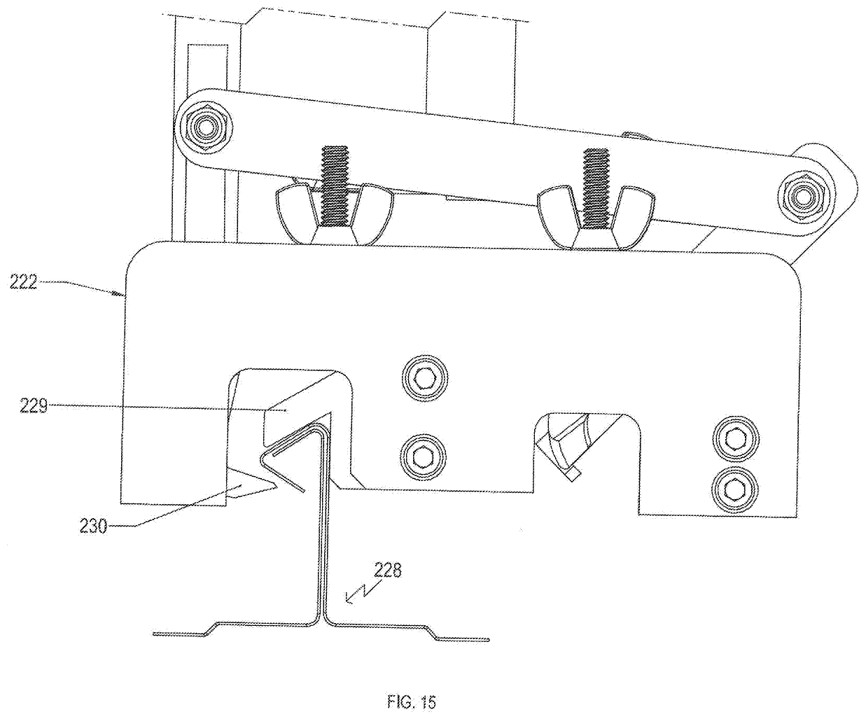

FIG. 12 shows a two-station manually crimping device 200 with operating arms 202, 204, a first crimping station 206, a second crimping station 208, and manually operated blades 210, 212, and directional anvils 214, 216 placed over an uncrimped seam 100. FIG. 13 shows the initial crimping of the seam 218 under the first station 206 and movement of the blade 210 as directed to a result by the anvil 214. FIG. 14 shows the finished crimping of the seam 220 under the second station 208 and movement of the second blade 212 as directed by the second anvil 216. The first station crimping is provided to show the juxtaposition from the first initial crimp to the second.

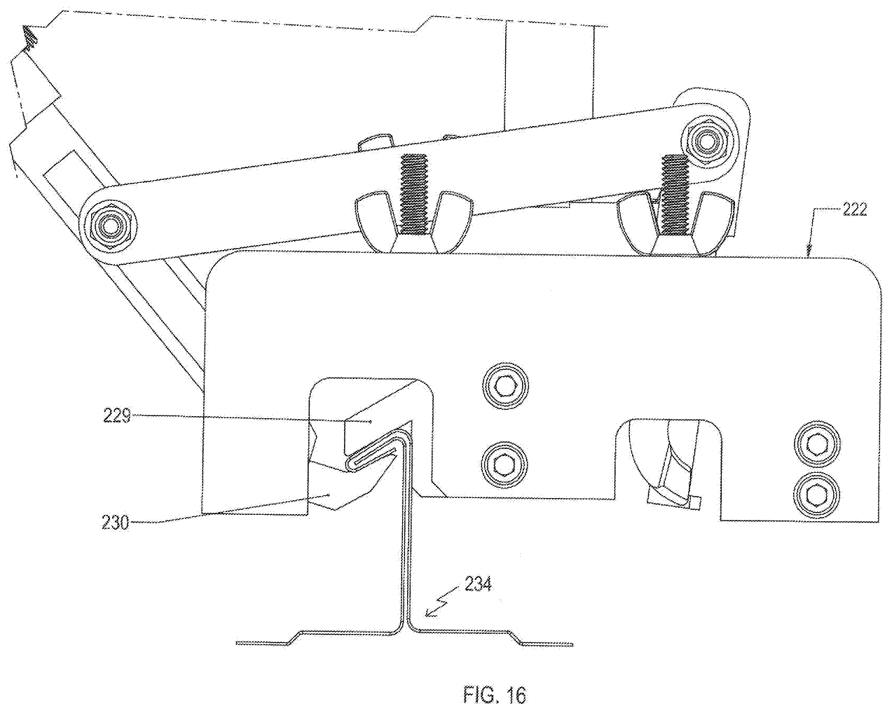

FIG. 15 thus shows a manual crimping device 222 having a different anvil 224 and blade 226 from that of FIG. 12. An initial crimp if provided under a first station 228 distinct from that of the result in FIG. 13 with such result due to the interchange (substitution) of the anvil 224 and blade 226 from those in FIG. 13 (210, 214). Likewise, to show the different results available through such substitution of a different anvil 229 and blade 230, FIG. 16 depicts a totally different crimp result 232 of the seam 234.

Thus, a manual crimping apparatus is provided that may be manually placed at any selected location along a standing seam for appropriate deformation of the seam components for reliable and secure engagement thereof, at least through movement of the flange component of such a standing seam to a desired location in relation to the male end and horizontal edge formed therein through a selected combination of interchangeable components. The ability to substitute any number and combination of such component parts allows for the same base crimping device to be utilized as desired to effectuate myriad resultant seaming configurations on roof seams between adjacent panels. This capability reduces the need for multiple manual crimping devices to be transported in case different seaming results are needed; to the contrary, a user may simply substitute small components within the same base crimping device to impart any desired crimping result. Whether a single station or two-station crimping device, the manual device(s) utilizing such interchangeable components allows for greater versatility and efficiency at the subject construction site. Such an apparatus has never been provided the metal building industry as of today.

Although the present invention has been described with a certain degree of particularity, it is understood that the present disclosure has been made by way of example and that changes and details of structure may be made without departing from the spirit thereof.

What is claimed is:

1. A manually operated crimping device for crimping a portion of a standing seam of adjacent metal panels when placed in a pre-selected location along said standing roof seam, wherein said standing seam is provided through contacting engagement of a male end of one metal panel properly nested within a female end of an adjacent metal panel, wherein, when overlapping one another, said standing seam is aligned as a substantially straight line having a vertical component rising to a horizontal component from which extends a flange component, and wherein said flange component extends at an angle of any measurement downward from said horizontal component of said standing seam; wherein said crimping device includes a manual crimping means to simultaneously bend substantially all of said flange component of said standing seam at the location at which said crimping device is placed, and wherein said crimping means is interchangeable through the removal and substitution of at least one different crimping component selected from an anvil, a blade, and a jaw hook, wherein a multiple of different variations of said at least one different crimping component is provided to accord multiple variations of resultant crimping configurations within the same device on demand
